(19) United States
(12) Patent Application Publication
(10) Pub. No.: US 2005/0249044 A1
(43) Pub. Date: Nov. 10, 2005

(54) Chronograph watch movement

(76) Inventors: Stephen Edward Methuen Forsey, Le Locle (CH); Robert Greubel, La Neuveville (CH)

Correspondence Address: MCGLEW & TUTTLE, PC, P.O. BOX 9227, SCARBOROUGH STATION, SCARBOROUGH, NY, 10510-9227, US

(21) Appl. No.: 10/528,300

(22) PCT Filed: Aug. 26, 2003
(86) PCT No.: PCT/IB03/03162

§ 371 Date: Mar. 16, 2005

(30) Foreign Application Priority Data
Oct. 7, 2002 (EP) 02022505.8

(51) Int. Cl. G04F 10/00

(52) U.S. Cl. 368/110

(57) ABSTRACT

The invention concerns a chronograph watch movement, comprising a chronograph mechanism, including: a chrono-graph gear-train comprising first (40) and second (38) wheels completing a revolution in sixty seconds and a revolution in a fraction of an hour respectively and arranged in the center of the movement, a control device (48) for starting and stopping the rotation of the chronograph gear-train, and a reset device (50). In said movement, the chronograph mechanism further comprises switching means designed such that, upon activation, they connect the second wheel (38) of the chronograph gear-train to a finishing mobile, so that the display means borne by the second wheel display the current time unit equivalent to that of the measured time.

### BACKGROUND OF THE INVENTION

The present invention concerns movements for chronograph watches. Such movements generally and conventionally comprise a frame, formed of a plate and bridges, and, carried by the frame:
an energy source,
a time base powered by the energy source,
a first, going train, driven in rotation in synchronism with the time base, and comprising a mobile for units of time selected from among the minutes and hours of the current time, and
a chronograph mechanism, which includes:
   a second, chronograph train, to be driven upon demand, in synchronism with the time base and comprising first and second wheels respectively completing one revolution in sixty seconds and one revolution in a time allowing the units of measured time, selected from among the hours and minutes, to be displayed and arranged coaxially with the first mobile, these wheels being arranged so that they can carry display means for displaying a measured time, for example hands, for indicating respectively the measured time seconds and the selected unit of the measured time,
   a control device for starting and stopping the rotation of the second train, and
   a device for resetting the display means.

Chronographs allow time intervals to be measured, by pressure on one or two push-buttons, mounted so as to slide on the watchcase, which control the chronograph mechanism. Successive applications of pressure assure the starting and stopping of the chronograph train, and consequently the start and end of the measurement.

The measured time is displayed by a chronograph second hand, carried by the first wheel of the chronograph train. Depending upon the type of chronograph, the first wheel also drives a wheel completing one revolution in thirty or sixty minutes and capable of carrying a measured time minute hand. This wheel is generally off-centre, such that the chronograph minute hand is smaller than the chronograph second hand.

Thus, in order to facilitate reading of the measured time minute, it is advantageous to have the chronograph minute hand at the centre of the movement. To prevent it being confused with the chronograph second hand, it has to be wider. As a result it tends to conceal the dial in the midday position when it is not operating. This can be inconvenient for reading the information given by the hands that are situated underneath, namely those for displaying the current time. It is an object of the present invention to overcome this drawback.

### SUMMARY OF THE INVENTION

This object is achieved owing to the fact that the chronograph mechanism further includes switching means arranged so that they can occupy two states and in one of which they connect the second wheel of the chronograph train to the going train mobile, so that the display means carried by the second wheel display the unit of the current time equivalent to that of the measured time.

Advantageously the unit of time displayed by the mobile and the second wheel mentioned hereinbefore is the minute. Consequently, while the first member connects the chronograph train wheel for displaying the minutes and the current time minute mobile, the minute hand, carried by the chronograph train wheel, is in a position corresponding to the display of the current time minutes.

More specifically, the switching means comprise a hammer pivotably mounted on the current time minute mobile, a cam secured to the second chronograph train wheel and an elastic member holding the hammer abutting against the cam.

In order to guarantee that the switching means operate perfectly as defined hereinbefore, the chronograph mechanism further includes an isolation device, which comprises:
an isolation mobile provided with a first plate, of the same diameter as the first mobile, and a second plate arranged for cooperating with a pawl or click and carrying a pin for activating the hammer,
a retaining member comprising a lever and a retaining wheel, mounted to be mobile in rotation on the lever and comprising first and second plates arranged to be able to mesh respectively with the first plate of the isolation mobile and the going train minute mobile, and connected to each other by a one-directional coupling mechanism, and
isolation control members comprising:
   an isolation lever,
   a pawl pivotably mounted on the lever and cooperating with the second plate of the isolation mobile, to move it with reference to the first plate, and with it the pin, which raises the hammer to interrupt the connection between the second wheel of the chronograph train and the going train minute mobile.

At the start of a time measurement, the chronograph second and minute hands must be at zero, to allow the user to know that his counter has been initialised. This could not happen when the measured time minute hand is superposed with the current time minute hand. Thus, in order to prevent any problem of comprehension as to operation, the chronograph mechanism further a locking device arranged for locking the control and reset devices while the switching means are connecting the second wheel of the chronograph train to the going train mobile.

In a first variant, the current time minute mobile is arranged to carry a current time minute hand and the second wheel of the chronograph train, a measured time minute hand. In this variant, when the switching means are in the state in which they connect the second wheel of the chronograph train to the going train mobile, the hands carried by the wheel and mobile are superposed.

In a second variant, only the second wheel of the chronograph train carries a hand, such that this hand displays the current time minutes while the locking device is locking the control device, and the measured time minutes in the opposite case. The information provided is thus reduced, but the watch is thinner, which improves its aesthetic appearance. It offers the advantage of providing a measured time minute display via a large hand, while only having three hands at the centre of the movement, namely those displaying the current time hour, the current time minute and the measured time minute as well as the measured time second.

Other advantages and features of the invention will appear from the following description, made with reference to the annexed drawings.

### BRIEF DESCRIPTION OF THE DRAWINGS

FIG. 1 shows a watch fitted with a movement according to the invention, in a state in which a measured time measurement is being carried out,

FIG. 2 is a logic operating diagram of the movement according to the invention,

FIG. 3 is a cross-section of the movement according to the invention,

FIGS. 4a to 4d show the dial side of the movement, in various states corresponding to the steps defined in the diagram of FIG. 2, and

FIG. 5 illustrates the back cover side of the movement, when the chronograph function is locked.

### DESCRIPTION OF THE PREFERRED EMBODIMENT

In the following description, the position of certain components is sometimes defined with reference to a time. This position corresponds to the position on the dial occupied by the hour symbol displaying the given time.

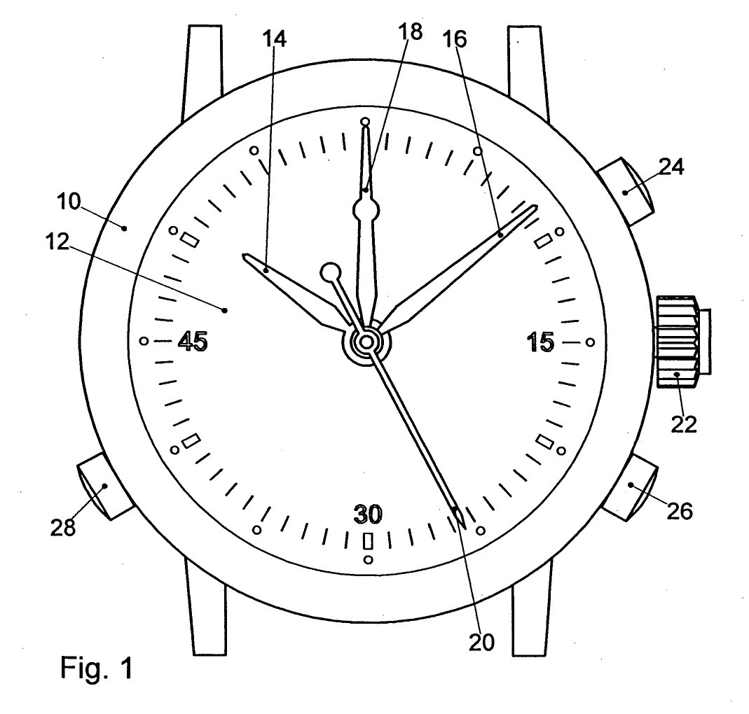

The watch shown in FIG. 1 is of the chronograph type. It comprises, in a conventional manner, a case 10 acting as housing for a movement, which carries a dial 12, a current time hour hand 14, a current time minute hand 16, measured time minute hand 18 and a measured time second hand 20.

The current time display is corrected by means of a time setting crown 22, connected to members of the movement by a time setting stem that is not visible in the drawing.

The timing related functions are performed by three push-buttons 24, 26 and 28 respectively disposed at two o'clock, four o'clock and eight o'clock. Push-button 24 controls the starting and stopping of a measured time measurement, whereas push-button 26 resets hands 18 and 20 when a measured time measurement has been interrupted. Finally, push-button 28 is for making the chronograph mechanism pass from a first state, in which it is locked, into a second state in which it is unlocked.

As will be explained hereinafter, the chronograph mechanism is arranged so that, when it is locked, current time minute hand 16 and measured time minute hand 18 are superposed and rotate together, whereas measured time second hand 20 is at midday. In this state, push-buttons 24 and 26 are inactive.

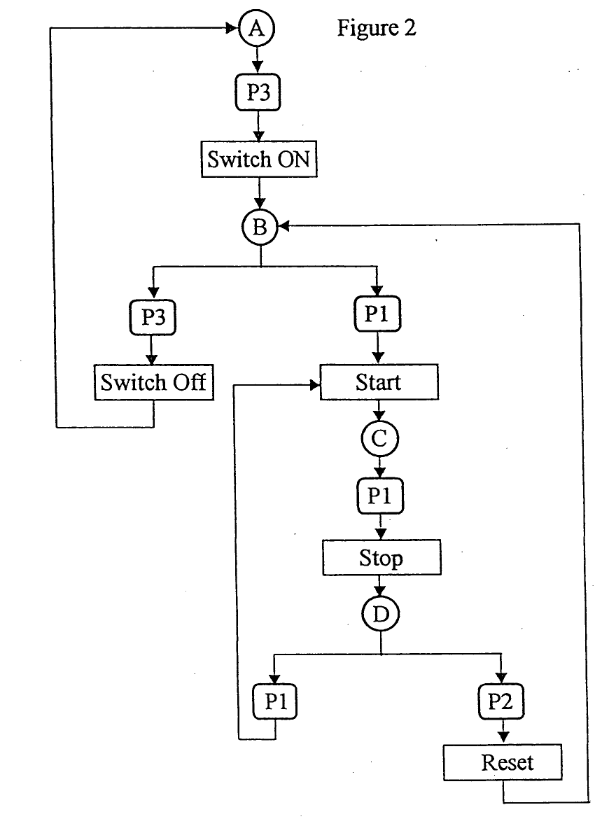

FIG. 2 illustrates the effect of the various push-buttons depending upon the states of the chronograph mechanism, which are identified by a capital letter surrounded by a circle. An application of pressure onto push-buttons 24, 26 and 28, respectively corresponds to the indications P1, P2 and P3 of the Figure.

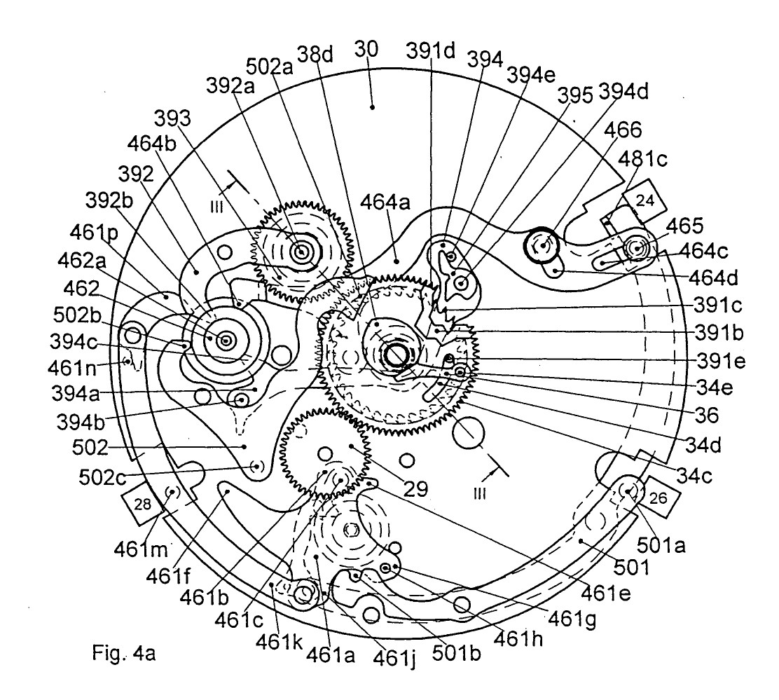

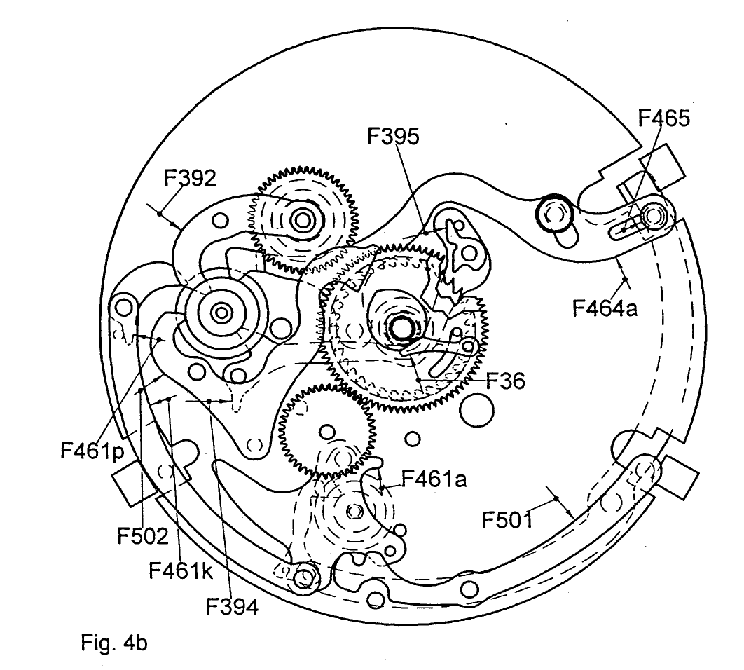

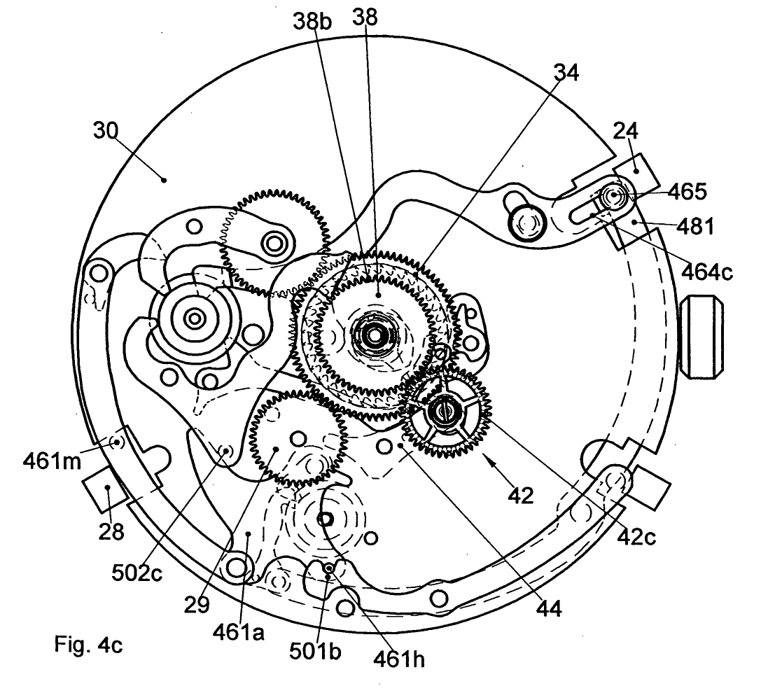

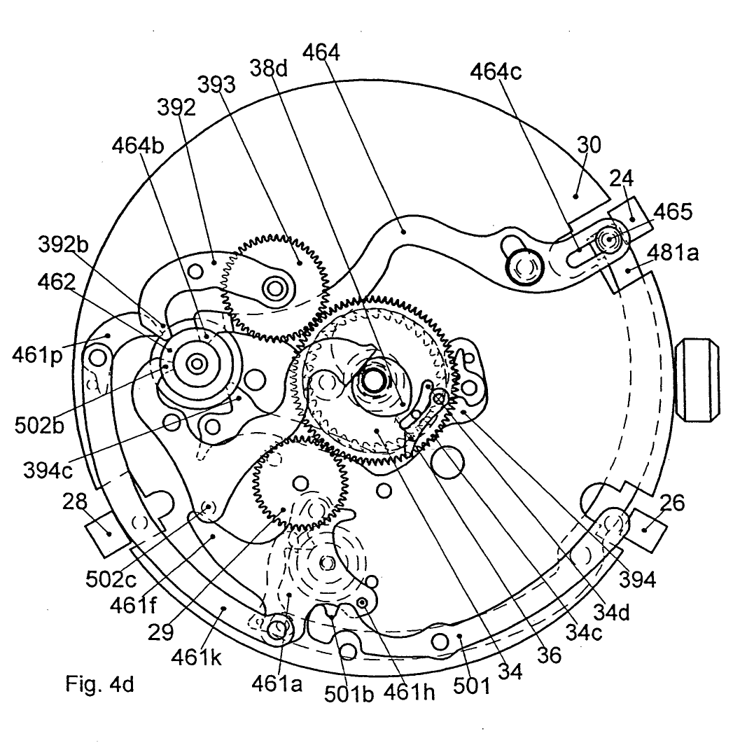

In the initial state, identified by A and corresponding to the situation illustrated by FIGS. 4a and 4b, the chronograph mechanism is locked. The chronograph second hand 20 is at midday and measured time minute hand 18 is superposed on current time minute hand 16, push-buttons 24 and 26 being inactive.

An application of pressure P3 causes the chronograph mechanism to unlock. As a result, measured time minute hand 18 leaves current time minute hand 16 to align at twelve o'clock, thus being superposed on the measured time second hand 20. This state, shown in FIG. 4c, is identified by the letter B.

In this state, push-buttons 24 (P1) and 28 (P3) are active. An application of pressure P1 has the effect of starting the counting of a measured time, the measured time second hand 20 starting to rotate and, more slowly, measured time minute hand 18. This state, shown in FIG. 4d and identified by the letter C, brings the display to the situation illustrated in FIG. 1.

In state B, an application of pressure P3 returns the chronograph mechanism to its initial state A.

In state C, only push-button 24 is active. An application of pressure P1 has the effect of stopping counting of the measured time. Hands 18 and 20 thus stop in the position corresponding to the measured time, which corresponds to state D, which differs from state B only in that the hands are not at zero.

Another application of pressure P1 then has the effect of restarting counting, the mechanism thus returning to state C, whereas an application of pressure P2 returns hands 18 and 20 to midday, which corresponds to state B.

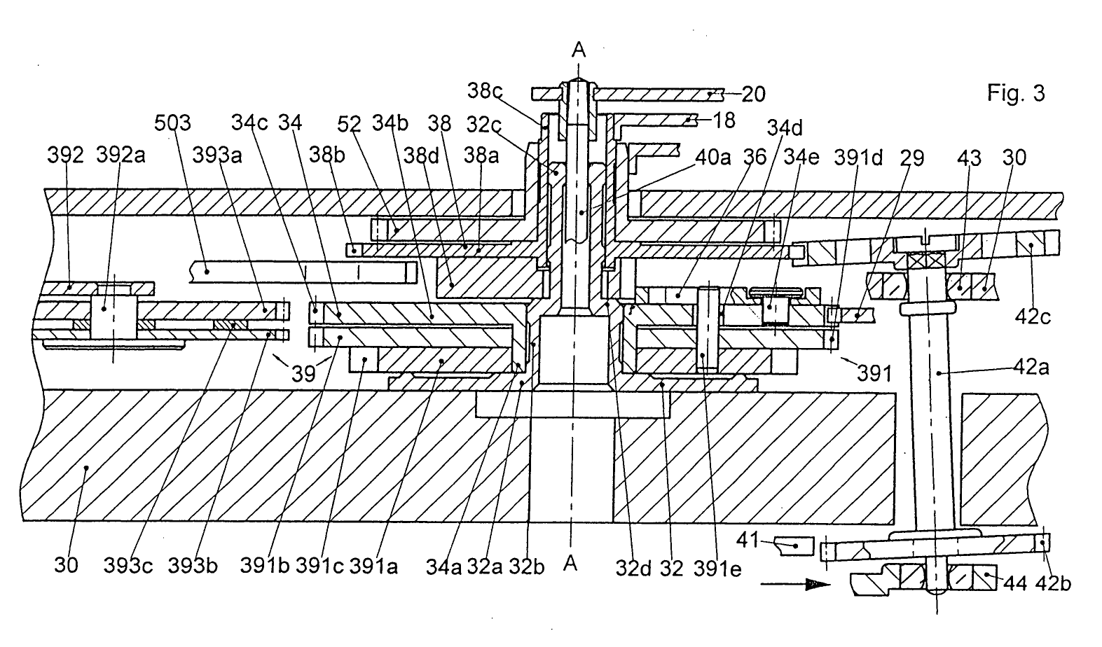

In a variant, achieved by means of a movement like that described with reference to FIGS. 3 to 5, current time minute hand 16 is omitted. Consequently, the current time is read by means of current time hour hand 14 and minute hand 18 while the movement is in state A, whereas in the other states, minute hand 18 displays the measured time, the current time minutes having to be evaluated from the position of current time hour hand 14.

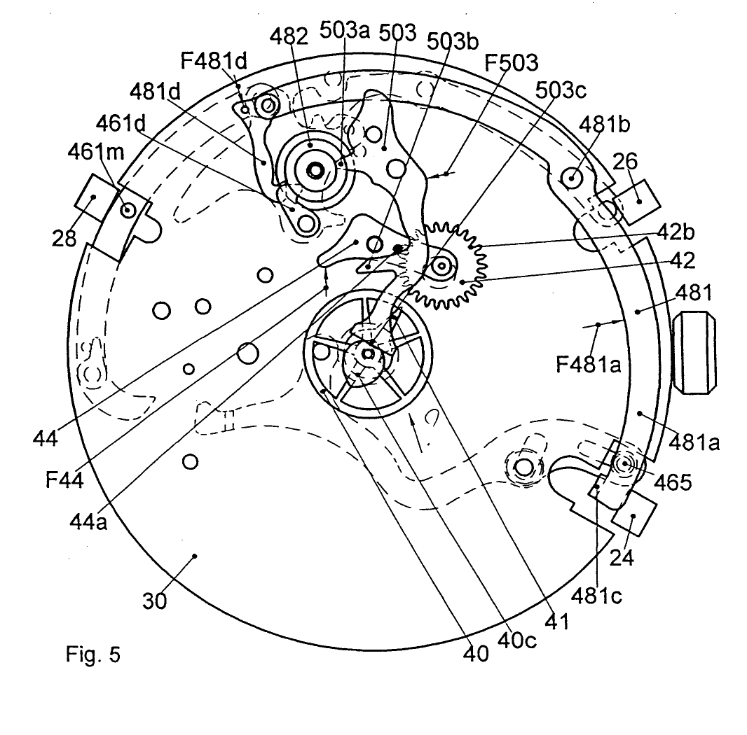

In FIGS. 4 and 5 and in order to avoid overloading the drawings, the springs have only been shown schematically, by means of an arrow showing the force that they generate, associated with a reference Fi, “i” being equal to the reference of the part on which the spring is acting. They are essentially visible in FIG. 4b.

More precisely, FIGS. 4a and 4b show the mechanism in its rest position, corresponding to state A, and FIGS. 4c and 4d in positions corresponding respectively to states B and C of FIG. 2. In FIGS. 4a to 4d, which show the dial side of the movement, some parts have been removed or partially torn away from one or other of these Figures, in order for the subjacent parts to be seen more clearly.

The terms “wheel” or “mobile” are used to differentiate between the components of the chronograph train and going train respectively.

The movement of the invention comprises, in a conventional manner that is not visible in the drawing, an energy source such as a barrel, a time base such as a sprung balance, a going train of which only one mobile 29 is visible in FIGS. 3 and 4, and an escapement connecting the going train to the balance in order to maintain the latter, as well as time setting and chronograph mechanisms. These various components of the movement are disposed on a frame 30, formed of a plate and bridges, which assures the relative positioning of the various mobile parts of the movement.

FIG. 3 shows the central part of the movement, seen in cross-section along the line III-III of FIG. 4a, with an axis A-A corresponding to the axis about which the hands pivot. Frame 30 carries, rigidly secured to its dial side face, a tube 32 comprising a seat 32a secured to frame 30 and two cylindrical portions 32b and 32c, whose axis merges with axis A-A, and arranged one after the other, connected by a shoulder 32d and designed to act as a fixed arbour for the pivoting of the mobiles and wheels, as will be explained hereinafter.

A current time minute mobile 34 is pivotably mounted so as to pivot on tube 32. It is provided with a pipe 34a engaged on cylindrical portion 32b of tube 32 and a plate 34b including a toothing 34c at its periphery. Pipe 34a, plate 34b and toothing 34c are made in a single piece.

Mobile 34 meshes permanently, via its toothing 34c, with mobile 29 of the going train, in a gear ratio selected such that it completes one revolution per hour of current time.

Plate 34b is provided with:
a cut out part 34d in the form of an annular portion covering an angle of approximately 50°, the function of which will be specified hereinafter,
a stud 34e, to which a connecting hammer is secured, and
a spring tending to return hammer 36 to the centre and schematically represented by arrow F36 (FIG. 4b).

A minute hand wheel 38 is pivotably mounted on cylindrical portion 32c of tube 32. This wheel 38 is only visible, in plan, in FIG. 4c. It comprises a plate 38a provided, at its periphery, with a toothing 38b, and a pipe 38c engaged on tube 32 and extending upwards sufficiently for its free end to be released and to allow minute hand 16 to be secured. The latter displays both the current time and the measured time, as will be explained hereinafter. Pipe 38c extends underneath plate 38a. A cam 38d, generally called a heart-piece, and more particularly visible in plan in FIGS. 4a, 4b and 4d, is secured by being driven in or welded thereto. Its lower face abuts against shoulder 32d. This cam 38d is arranged such that it can cooperate with hammer 36, as will be explained hereinafter.

The movement comprises an isolating device whose components' reference starts with 39 and which includes an isolation mobile 391 mounted on pipe 34a, a lever 392, a retaining wheel 393 pivotably mounted on lever 392, an isolation lever 394 and a pawl or click 395 mounted on lever 394 (FIG. 4a).

Mobile 391 comprises two superposed plates 391a and 391b, rigidly connected to each other and provided at their periphery with toothings respectively referenced 391c and 391d, and a pin 391e secured in plate 391a. This lower plate is provided with wolf teeth, clearly visible in FIG. 4a, whereas toothing 391d, of upper plate 391b comprises the same number of teeth and has the same profile and same diameter as toothing 34c. Pin 391e is engaged in cut out part 34d and extends as far as hammer 36.

Retaining lever 392 is mounted on frame 30, pivoting in its median part. It carries, at one of its ends, wheel 393 which can rotate on a stud 392a driven into lever 392, whereas the other end forms a nose 393b which, as will be explained hereinafter is for controlling the movement of lever 392. A spring F392 tends to apply nose 392b onto a support surface.

As shown schematically in FIG. 3, wheel 393 is formed of two plates 393a and 393b, connected to each other by a click 393c and respectively capable of being meshed with toothings 34c and 391d. Click 393c is arranged such that, when mobile 34 is rotating in the clockwise direction, the click is locked, such that plate 393b drives mobile 391 in rotation. If, conversely, it is the latter that is being rotated in the clockwise direction, only plate 393b is driven, click 393c performing its disconnecting function.

Lever 394 comprises (FIG. 4a):
a body 394a pivotably mounted on frame 30, by the engagement of a hole 394b made at one of the ends of body 394a of the lever in an unreferenced stud, secured to frame 30,
a nose 394c, located in proximity to hole 394b for controlling the movement of lever 394,
a stud 394d driven into the body at the opposite end to that provided with hole 394b, on which pawl 395 pivots, and
a pin 394e, forming a stop member and limiting the movement of pawl 395.

Lever 394 is positioned by nose 394c abutting against a support surface, via the action of a spring F394. A spring F395 tends to hold pawl 395 abutting against pin 394e.

Isolation mobile 391 can be moved by an angle of approximately 45° with respect to mobile 34, by the engagement of pawl 395 in toothing 391c. During this movement, pin 391e, moving freely in cut out part 34d, raises hammer 36 whose free end is brought back towards the exterior.

When the chronograph mechanism is locked, by means that will be explained hereinafter, hammer 36, positioned by spring F36, which tends to apply it against cam 38d, performs the function of connecting member between mobile 34 and wheel 38, which are thus secured to each other in rotation. This thus means that minute hand 18, carried by pipe 38c of wheel 38, displays the minutes of the current time.

In order to count the measured time, the movement shown in the drawing comprises a chronograph second hand 40, pivotably mounted in tube 32, visible in FIG. 5 and partially in FIG. 3, and a sliding gear 42 (FIGS. 3 and 4c). Wheel 40 comprises an arbour 40a pivotably mounted in tube 32 and in frame 30, a plate 40b driven onto arbour 40a and provided with a toothing, a cam 40c, also driven onto arbour 40a, and a drive finger 41.

The chronograph mechanism further includes a coupling mechanism, not visible in the drawing, provided with a wheel which, when the chronograph mechanism is in state C, kinematically connects wheel 40 to the going train, such that it is driven in rotation, at a rate of one revolution per minute. Such a coupling mechanism is well known to those skilled in the art.

Slide gear 42 comprises an arbour 42a (FIG. 3) rotatably mounted in a jewel 43, with an olive jewel-hole, driven onto a bridge of frame 30 and onto a lever 44, itself pivoting on frame 30 and which will be described in more detail hereinafter. It further comprises two wheels 42b and 42c, for cooperating respectively with finger 41 and wheel 38. Depending upon the position that lever 44 occupies, wheel 42b is either in the space swept by finger 41 or not. Moreover, wheel 42c is permanently meshed with toothing 38b. Lever 44 tends to move in the direction of the centre of the movement via the effect of a spring F44 (FIG. 5).

When the chronograph mechanism is in one of states B, C or D, hammer 36 is raised by pin 391e, such that it is no longer abutting against cam 38d. Mobile 34 and wheel 38 are thus no longer secured in rotation. Moreover, when the mechanism is in state C, arbour 42a is arranged parallel to axis A-A and its wheel 42b can be driven in rotation by finger 41, at a rate of one step for each revolution of wheel 40. In other words, slide gear 42 performs the function of a connecting member between measured time second wheel 40 and wheel 38, so that the latter displays the measured time minutes when the mechanism is in state C or D.

The connecting members formed by hammer 36, spring F36 and cam 38d on the one hand, and slide gear 42 on the other hand, perform together the function of switching means.

Since current time minute mobile 34 is permanently rotating, driven by the going train, isolation mobile 391 has to rotate with it, otherwise hammer 36 cannot be controlled. Therefore, retaining wheel 393 is made to mesh with toothings 34c of mobile 34 and 391d of isolation mobile 391, the two plates 393a and 393b being secured to each other in rotation by click 393c.

In order to perform the functions as defined with reference to FIG. 2, the chronograph mechanism shown in FIGS. 4 and 5 comprises, in addition to the gear trains and the isolation device described hereinbefore:
a switch for enabling or disabling the timing function, and whose constituent parts are defined by references starting with 46,
a control device, controlling the starting and stopping of a measurement, and whose constituent parts are defined by references starting with 48, and
a reset device, for reinitialising the measured time counters, and whose constituent parts are defined by references starting with 50.

It should be noted that these devices interact and that some parts are arbitrarily defined as forming part of one device rather than another.

Switch 46 is controlled by push-button 28. It allows minute hand 16 to be returned to zero, and push-button 24 to be made active. It comprises, for this purpose (FIG. 4a):
a switching member 461, comprising:
   a bird-shaped body 461a, with a head 461b provided with a hole 461c in which there is engaged a stem passing right through frame 30 and carrying a finger 461d visible in FIG. 5, a beak 461e, two wings 461f and 461g, wing 461g being provided with a pin 461h, and a tail 461j, the head being disposed on the centre side of the movement and tail 461j at the periphery, in proximity to 7 o'clock,
   a lever 461k pivotably mounted on tail 461j and extending over the periphery of the movement from 7 to 9 o'clock, provided with a pin 461m disposed so that it is or is not located on the path travelled by push-button 28, when it is activated depending upon the position occupied by lever 461k, and a stop member 461n arranged at its free end,
   a pawl 461p pivotably mounted on lever 461k and limited in its movement by stop member 461n,
a switching cam, for example a column wheel 462, shown schematically, controlled in rotation by pawl 461p, rotating on frame 30 at 462a, and cooperating with noses 392b of lever 392 and 394c of lever 394,
an interlocking lever 464, comprising a body of elongated shape 464a, pivotably mounted on frame 30 in its median part, and one of whose ends is provided with a nose 464b arranged for cooperating with the columns of wheel 462, whereas the other end comprises a first oblong hole 464c in which a stud 465 is mounted to slide, for cooperating with control device 48, and a second oblong hole 464d, in which a pin 466 with a head is housed, itself secured to frame 30, for positioning the lever in the plane of the movement.

The constituent parts of switch 46 are positioned by springs shown schematically in FIG. 4b and more particularly:
body 461a by spring F461a,
lever 461k by spring F461k which tends to return it when pressure has been applied to push-button 28,
pawl 461p by spring F461p which holds it pressed against pin 461n,
body 464a by spring F464a, which tends to apply nose 464b against wheel 462, and
stud 465 by spring F465, which tends to press it on the external side of oblong hole 464c.

Control device 48 is more particularly visible in FIG. 5. It comprises:
a control lever 481 comprising:
   a body 481a disposed at the periphery of the movement from 2 to 7 o'clock, which pivots at 481b on frame 30 slightly below 4 o'clock, and which is provided, at one of its ends, with a bent portion 481c extending into the thickness of stud 465, and
   a pawl 481d, pivotably mounted on the other end of body 481a, whose function will be specified hereinafter,
a cam 482, for example of the column wheel type, driven by pawl 481d, which controls the coupling mechanism of the chronograph, not shown in the drawing, and positions switching member 461 via its finger 461d.

The constituent parts of control device 48 are positioned by springs and more particularly:
body 481a, by spring F481a which tends to return it when pressure has been applied to push-button 24, and
pawl 481d, by spring F481d, which applies it against cam 482.

Reset device 50 comprises:
a reset lever 501 (FIG. 4a) arranged and pivotably mounted at the periphery of frame 30 and extending from 4 o'clock to 6 o'clock, provided at its end in proximity to 4 o'clock with a pin 501a for cooperating with push-button 26, and at its other end with a groove 501b for cooperating with pin 461h,
a hammer 502 for resetting the minutes arranged in proximity to column wheel 462 and extending as far as the central part of the movement to cooperate with cam 38d via a support surface 502a provided with:
   a nose 502b which cooperates with column wheel 462, and
   a pin 502c for cooperating with wing 461f, and
a hammer 503 for resetting the seconds (FIG. 5) pivotably mounted on the opposite face of frame 30 in proximity to cam 482, provided with:
   a nose 503a cooperating with cam 482,
   a retaining finger 503b cooperating with lever 44 via a pin 44a comprised in the latter, and
   a support surface 503c for returning the second hand to zero by abutting against cam 40c.

The constituent parts of reset device 50 are positioned by springs and more particularly:
lever 501 by spring F501, which tends to return it after pressure has been applied on push-button 26,
hammer 502 by spring F502, which tends to apply support surface 502a against cam 38d, and
hammer 503 by spring F503, which tends to apply it against cam 40c.

The movement further comprises a current time hour mobile 52, pivotably mounted on pipe 38c of minute hand wheel 38. Mobile 52 carries current time hour hand 14. It is kinematically connected to mobile 34 by a motion work, which divides the movement by a factor of 12. This motion work has not been shown to avoid overloading the drawing.

When the chronograph mechanism is at rest, namely in state A defined with reference to FIG. 2, its constituent parts are in the position shown in FIGS. 4a, 4b and 5. More particularly, nose 392b of retaining lever 392 is between two columns of column wheel 462 via the effect of spring F392, such that retaining wheel 393 is not meshed with toothings 34c and 391d. Nose 394c of lever 394 is also between two columns via the effect of spring F394, so that pawl 395 is withdrawn from toothing 391c. Thus, via the action of spring F36, hammer 36 is abutting against cam 38d. Wheel 38 of the minute hand is rotating, consequently, in synchronism with current time minute mobile 34.

The interlocking lever 464 is abutting, via its nose 464b and via the effect of spring F464a, against a column of wheel 462, such that stud 465 is not inserted between push-button 24 and bent portion 481c, which disables push-button 24. Moreover, an action on push-button 26 causes lever 501 to pivot, but without it acting on any of the other parts.

An application of pressure on push-button 28 activates pin 461m, which drives with it lever 461k, which causes the chronograph mechanism to switch. More precisely, the tipping of lever 461k drives pawl 461p, which rotates column wheel 462 and generates the following movements, which occur practically simultaneously or in the following order:
nose 392b of retaining lever 392 is raised by a column, which causes wheel 393 to mesh with toothings 34c and 391d;
nose 394c of lever 394 is raised, such that pawl 395 meshes with toothing 391c, driving in rotation, clockwise, mobile 391 and the single plate 393b, plate 393a, meshed with mobile 34, being disconnected, because of click 393c;
during the relative movement of mobile 391 with reference to mobile 34, pin 391e raises hammer 36, such that cam 38d of wheel 38 is no longer maintained in phase with mobile 34;
nose 502b of hammer 502 falls, via the effect of spring F502, between two columns of wheel 462, support surface 502a cooperating with cam 38d such that wheel 38, which carries hand 18, brings the latter to midday, and
nose 464b of interlocking lever 464 falls between two columns of wheel 462 via the effect of spring F464a, bringing stud 465 between push-button 24 and bent portion 481c.

The mechanism is then in state B defined in FIG. 2 and shown in FIG. 4c. The connecting member formed by hammer 36 and cam 38d then no longer provides a connection between wheel 38 and mobile 34. Switch 46 thus plays the part of control member, and deactivates the connecting member.

In this state, push-buttons 24 and 28 are operational. If push-button 28 is pressed again, lever 461k, tips and drives pawl 461p. This causes column wheel 462 to rotate, which generates the following movements, which occur practically simultaneously or in the following order:
nose 392b of retaining lever 392 falls between two columns of wheel 462 via the effect of spring F392, wheel 393 thus being released from toothings 34c and 391d;
nose 502b is raised by a column, such that hammer 502 releases cam 38d;
nose 394c falls back between two columns and lever 394 returns to the position shown in FIG. 4a via the effect of spring F394;
via the effect of spring F36, hammer 36 tips and abuts against pin 391e, which causes isolation mobile 391 to rotate, then against cam 38d which drives wheel 38 until hand 18 again displays the minutes of the current time; and
nose 464b of interlocking lever 464 is raised by a column of wheel 462 such that stud 465 leaves the space comprised between bent portion 481c and push-button 24.

The mechanism has thus returned to state A shown in FIG. 4a.

From state B, shown in FIG. 4c, it is also possible to actuate push-button 24, which has the effect of starting a measured time measurement. More specifically, push-button 24 abuts against stud 465, which slides into oblong hole 464c and, applied against bent portion 481c, causes body 481a of lever 481 to pivot. Its pawl 481d, more particularly visible in FIG. 5, causes cam 482 to rotate through one step. This movement of cam 482 generates the movements described hereinafter, which occur practically simultaneously or in the following order:
hammer 503, visible in FIG. 5, is raised via its nose 503a, such that support surface 503c is released from cam 40c;
the chronograph coupling mechanism causes the coupling wheel to mesh both with the going train and the chronograph second wheel 40, so that the latter is driven in rotation and, with it, chronograph second hand 20;
retaining finger 503b releases pin 44a from lever 44, such that spring F44 causes lever 44 to pivot, wheel 42b being then positioned such that it is in the space swept by finger 41, which can then rotate slide gear 42 and, via the latter, minute hand wheel 38, at a rate of one step per minute, and
finger 461d is raised by a column of cam 482, which causes body 461a (FIG. 4b) and lever 461k of switching member 461 to tip. Consequently, pin 461m is shifted with respect to push-button 28, thus disabling the latter. Moreover, wing 461f raises hammer 502 via its pin 502c, thus allowing minute hand wheel 38 to rotate.

Moreover, the pivoting of body 461a brings its pin 461h into groove 501b of reset lever 501. During this operation, the connecting member formed by slide gear 42, controlled by control device 48 via hammer 503, passes from the deactivated state to the activated state.

The mechanism is then in the position shown in FIG. 4d, which corresponds to state C of FIG. 2. In this state, only push-button 24 is active. In fact, pin 461m is shifted with respect to push-button 28, which disables the latter. Moreover, body 461a, whose position is defined by finger 461d abutting against a column of cam 482, remains in this position, even if groove 501b releases pin 461h. In other words, an application of pressure on push-button 26 has no effect.

An application of pressure on push-button 24 causes it to abut against stud 465 which slides into oblong hole 464c and, applied against bent portion 481c, causes lever 481 to pivot. Its pawl 481d (FIG. 5) causes cam 482 to rotate through another step. This movement of cam 482 generates the movements described hereinafter, which occur practically simultaneously, or in the following order:
the chronograph coupling mechanism is moved, such that chronograph second wheel 40 is no longer connected to the going train, which means that it stops;
finger 461d passes from abutting against a column of cam 482 to a position in which it is between two columns, without, however, body 461a and finger 461d pivoting, since body 461a is retained by pin 461h engaged in groove 501b of lever 501; and
nose 502a of hammer 502 is between two columns of wheel 462, but it does not change position, because of pin 502c which is abutting against wing 461f of body 461a.

Hammer 503 is retained by similar means to those retaining hammer 502, but they have not been shown in order to avoid overloading the drawing. The chronograph mechanism is then in state D of the logic diagram of FIG. 2. This state, which is not shown in the drawing, allows action on push-buttons 24 and 26. An application of pressure on push-button 24 starts the time count, the mechanism returning to state C via another rotation of cam 482. Thus, the chronograph coupling mechanism is coupled again, whereas nose 503a of the hammer and finger 461d are abutting against a column of cam 482.

When the mechanism is in state D, an application of pressure on push-button 26 drives lever 501 which, by pivoting, releases pin 461h. Since finger 461d is between two columns of cam 482, nothing is holding it any longer, such that spring F461a returns switching member 461 to the position shown in FIG. 4b. Moreover, hammer 502 is no longer held by wing 461f, such that its spring F502 causes it to tip and abut against cam 38d, which has the effect of resetting minute hand 18 to zero.

A similar process is applied to hammer 503, such that cam 40c is also subjected to a force that returns measured time second hand 20 to midday. The chronograph mechanism is then again in state B defined hereinbefore, such that it is possible to press on push-button 28, to return the mechanism to state A, where push-buttons 24 and 26 are disabled and where minute hand 18 displays the minutes of the current time. It is also possible to press on push-button 24 in order to start a new measurement, the mechanism then being in state C.

The mechanism described with reference to FIGS. 3 to 5 comprises only one minute hand, which either displays the current time, or the measured time. It would also be possible, with a minor alteration, to have a hand 16 permanently displaying the current time minutes, whereas hand 18 displays the measured time minutes, as shown in FIG. 1. In order to do this, one need only provide mobile 34 with a pipe extending in the direction of the dial and which would insert the end thereof carrying hand 16 between pipe 38c of wheel 38 and tube 32.

Many other variants can also be envisaged, wherein the constituent parts of the members of the chronograph mechanism could take other forms and cooperate very differently, without thereby departing from the scope of the invention. Thus, column wheels 462 and 482 could advantageously be replaced by pivoting cams. It would also be possible to use an axial and/or friction coupling device, instead of mobile 42.

It is also entirely possible to envisage placing the current time hour hand off-centre and keeping only the measured time minute and second hands and the current time minute hand at the centre of the movement.

It is evident that the principle described is also applicable to the current time and measured time hour display, the hour hands either being central or off-centre.

In a variant that has not been described, it is also possible to omit switch 46, and consequently push-button 28, such that, when push-button 26 is activated, second hand 20 starts to rotate whereas minute hand 18 passes from the position where it is superposed on hand 16 to alignment at midday.

Thus, owing to the features described in the chronograph mechanism forming the subject of the present invention, it is possible to make a watch wherein the measured time minute and/or hour hand does not overload the display during the time when the mechanism is not in operation. Moreover, the mechanism enables the start, stop and reset functions to be locked, when there is no measurement being carried out.

1. A chronograph watch movement, including a frame and, carried by said frame:
an energy source,
a time base powered by the energy source,
a first, going train, driven in rotation, in synchronism with the time base, and including a mobile for units of time selected from among the minutes and hours of the current time, and
a chronograph mechanism, which includes:
a second, chronograph train, to be driven, upon demand, in synchronism with the time base and including first and second wheels respectively completing one revolution in sixty seconds and one revolution in a time allowing the measured units of time, selected from between the hours and minutes, to be displayed and arranged coaxially with said mobile, said wheels being arranged so that they can carry display means for displaying a measured time,
a control device for starting and stopping said wheels of the second train, and
a device for resetting the display means,
wherein said mechanism further includes switching means arranged such that they can occupy two states, in one of which they connect the second wheel of the chronograph train to the mobile of the going train, such that the display means carried by the second wheel display the unit of current time equivalent to that of the measured time.

2. A movement according to claim 1, wherein said unit of current time and said unit of measured time is a minute.

3. A movement according to claim 2, wherein the switching means include a hammer pivotably mounted on the mobile, a cam secured to the second wheel and an elastic member holding the hammer abutting against the cam.

4. A movement according to claim 3, further provided with an isolation device which includes:
an isolation mobile including a first plate of the same diameter as the first mobile, and a second plate arranged for cooperating with a pawl and provided with a pin for activating the hammer,
a retaining member comprising a lever and a retaining wheel, mounted to be mobile in rotation on the lever and comprising first and second plates arranged to be able to mesh respectively with the first plate of the isolation mobile and the minute mobile of the first train, and connected to each other by a one-directional coupling mechanism, and
isolation control members comprising:
an isolation lever,
a pawl pivotably mounted on the lever and cooperating with the second plate of the isolation mobile, to move it with reference to the first plate, and with it said pin, which raises the hammer to interrupt the connection between the second wheel of the second train and the minute mobile of the going train

5. A movement according to claim 2, wherein the chronograph mechanism further includes a locking device arranged for locking the control device while the switching means are connecting the second wheel of the second train to said mobile.

6. A movement according to claim 5, wherein said mobile carries a current time minute hand and the second wheel a measured time minute hand, such that, while the locking device is locking the control device, the switching means position the second wheel with reference to the first mobile such that the two hands are superposed.

7. A movement according to claim 5, wherein only the second wheel carries a minute hand, such that the latter displays the current time minutes while the locking device is locking the control device, and the measured time minutes in the opposite case.
